(19) United States
(12) Patent Application Publication
(10) Pub. No.: US 2004/0013904 A1
(43) Pub. Date: Jan. 22, 2004

(54) Light-emissive polymer blends and light-emissive devices made from the same

(76) Inventor: Salvatore Cina, Grenoble (FR)

Correspondence Address: James P Zeller, Marshall Gerstein & Borun, 6300 Sears Tower, 233 South Wacker Drive, Chicago, IL, 60606-6357, US

(21) Appl. No.: 10/398,142

(22) PCT Filed: Oct. 2, 2001
(86) PCT No.: PCT/GB01/04381

(30) Foreign Application Priority Data
Oct. 3, 2000 (GB) 0024155.4

(51) Int. Cl. H05B 33/14

(52) U.S. Cl. 428/690; 428/917; 313/504; 252/301.35; 257/40

(57) ABSTRACT

A polymer blend comprising a first, light-emissive polymer comprising substituted or non-substituted units according to formulae (I) and (II) and a second, hole transport polymer comprising substituted or non-substituted fluorene units according to formula (I) and substituted or non-substituted triarylamine units, wherein the molecular weights of the first and second polymers and the blending ratio of the first and second polymers are selected such that, in use in a light-emissive device, the luminance of the emitted light at a bias of 5V is no less than 20,000 cd/m² formula (I) (II): wherein R′ is independently in each occurrence H, C₁-C₂₀ hydrocarbyl or C₁-C₂₀ hydrocarbyl containing one or more S, N, O, P or Si atoms, C₄-C₁₆ hydrocarbyl carbonyloxy, C₄-C₁₆ aryl(trialkylsiloxy) or both R′ may form together with the 9-carbon on the fluorene ring a C₅C₂₀ cycloaliphatic structure containing one or more heteroatoms of S, N or O.

The present invention relates to novel light-emissive polymer blends, and to light-emissive devices made from such blends.

Light-emissive devices typically comprise a layer of electroluminescent material arranged between two electrodes such that charge carriers can move between the electrodes and the light-emissive material. Charge transport layers may be interposed between the layer of electroluminescent material and either or both of the electrodes.

The use of blends of conjugated polymers as the active material in light-emissive devices is disclosed in WO99/48160, WO99/54385 and WO00/46321. For example, WO99/48160 describes a device comprising in active layer comprising a tri-blend of poly(2,7-9,9-di-n-octylfluorene), poly(2,7-(9,9-di-n-octylfluorene)-3,6-benzothiadiazole) and poly(2,7-(9,9-di-n-octylfluorene)-(1,4-phenylene-((4-secbutylphenylimino)-1,4-phenylene)); and WO00/046321 describes a device having an active layer comprising a bi-blend of poly(2,7-(9,9-di-n-octyfluorene)-3,6-benzothiadiazole) and a polymer comprising 9,9-di-n-octylfluorene units, benzothiadiazole units and 1,4-phenylene-((4-secbutylphenylimino)-1,4-phenylene units in a ratio of 3:2:1.

According to a first aspect of the present invention there is provided a polymer blend comprising a first, light-emissive polymer comprising substituted or non-substituted units according to formulae (I) and (II) and a second, hole transport polymer comprising substituted or non-substituted fluorene units according to formula (I) and substituted or non-substituted triarylamine units, wherein The molecular weights of the first and second polymers and the blending ratio of the first and second polymers are selected such that, in use in a light-emissive device, the luminance of the emitted light at a bias of 5V is no less than 20,000 cd/m².

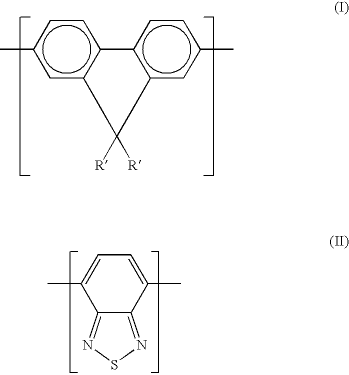

wherein R′ is independently in each occurrence H, C₁-C₂₀ hydrocarbyl or C₁-C₂₀ hydrocarbyl containing one or more S, N, O, P or Si atoms, C₄-C₁₆ hydrocarbyl carbonyloxy, C₄-C₁₆ aryl(trialkylsiloxy). For example, each R′ may be an alkyl group or an aryl group such as phenyl or biphenyl. Alternatively, both R′ may form together with the 9-carbon on the fluorene ring a C₅-C₂₀ cyclic such as a cycloaliphatic or a cycloaromatic structure optionally containing one or more heteroatoms of S, N or O. For example, R′ may together form an additional fluorene ring to form a spirofluorene unit.

In one embodiment, the polymer blend consists essentially of the first and second polymers.

The luminance value specified above and in claim 1 refers to the luminance in a device of the kind described in detail hereafter.

According to a second aspect of the present invention, there is provided a polymer blend consisting essentially of a first, light-emissive polymer comprising substituted or non-substituted units according to formulae (I) and (II) below and a second, hole transport polymer consisting essentially of substituted or non-substituted fluorene units according to formula (I) and substituted or noon-substituted triarylamine units, and optionally one or more further hole transport polymers different to the second polymer.

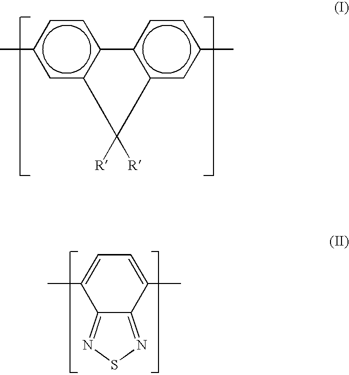

wherein R′ is independently in each occurrence H, C₁-C₂₀ hydrocarbyl or C₁-C₂₀ hydrocarbyl containing one or more S, N, O, P or Si atoms, C₄-C₁₆ hydrocarbyl carbonyloxy, C₄-C₁₆ aryl(trialkylsiloxy) or both R′ may form together with the 9-carbon on the fluorene ring a C₅-C₂₀ cyclic structure optionally containig one or more heteroatoms of S, N or O.

The fluorene unit may also optionally be substituted at one or more other positions by a group selected from C₁-C₂₀ hydrocarbyl, C₁-C₂₀ hydrocarbyloxy, C₁-C₂₀ thioether, C₁-C₂₀ hydrocarbylcarbonyloxy or cyano. The fluorene unit is preferably unsubstituted (i.e. has hydrogen atoms) at all other positions.

The benzothiadiazole unit may also be optionally substituted at either or both the carbons available for substitution with groups independently selected from C₁-C₂₀ hydrocarbyl, particularly C₁-C₂₀ alkyl, or C₁-C₂₀ hydrocarbyl containing one or more S, N, O, P or Si atoms, C₄-C₁₆ hydrocarbyl carbonyloxy, C₄-C₁₆ aryl(trialkylsiloxy). It is preferably unsubstituted, i.e. has hydrogen atoms at each of the two carbon atoms available for substitution.

The triarylamine unit preferably comprises two aryl groups that are linked together by a nitrogen atom and form part of the polymer chain and a third aryl group which is also bonded to the nitrogen atom and is pendant from the polymer chain. The triarylamine unit may be substituted at one or more positions on the pendant aryl group with one or more groups R″ independently selected from C₁-C₂₀ alkyl (particularly trifluoromethyl), C₁-C₂₀ alkoxy or a group of the formula —CO₂R′″ wherein R′″ is a C₁-C₂₀ alkyl.

The term “hole transport polymer” refers to a polymer which conducts mainly holes inside the polymer blend.

The proportion of the first polymer in the polymer blend is preferably in the range of 50 to 75 weight percent, further preferably in the range of 60 to 70 weight percent

The first polymer preferably has a peak molecular weight (Mp) in the range of 150,000 to 300,000, and a number-average molecular weight (Mn) in the range of 70,000 to 180,000, as measured by size exclusion chromatography calibrated with polystyrene standard.

If the device is used as part of a passive matrix display, it is preferred that the proportion of the first polymer in the polymer blend is at least 70%.

According to another aspect of the present invention, there is provided a light-emissive device comprising a layer of a light-emissive material interposed between first and second electrodes such that charge carriers can move between the first and second electrodes and the light-emissive material, wherein the light-emissive material comprises a polymer blend according to either the first or second aspects of the present intention. According to another aspect of the present invention, there is provided a passive matrix display comprising such a light-emissive device.

An embodiment of the present invention is described hereunder, by way of example only, with reference to the accompany drawings, in which:

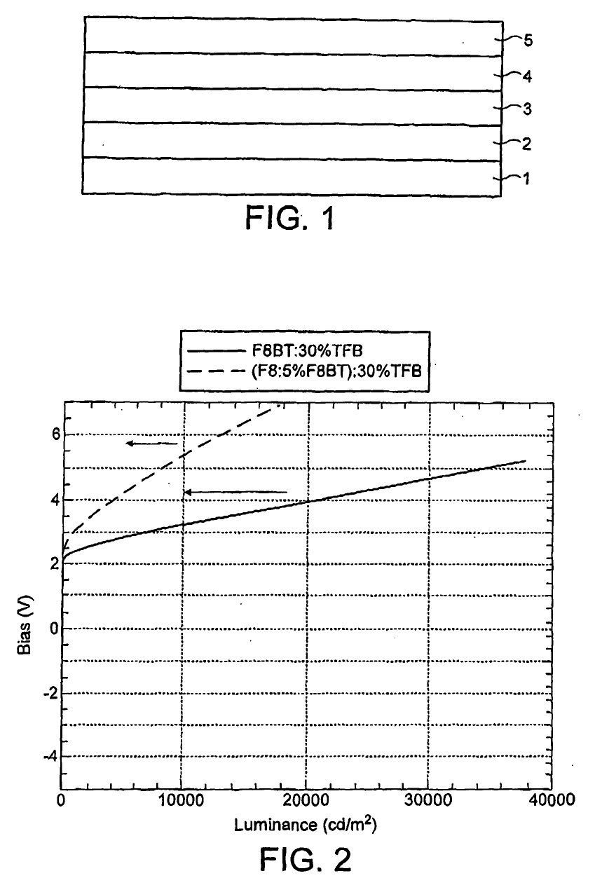

FIG. 1 is a schematic view of a light-emissive device;

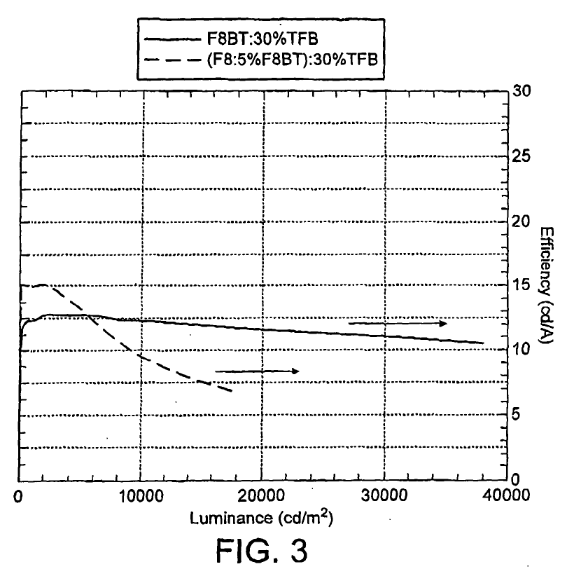

FIGS. 2 and 3 are graphs showing the improved performance of a device according to the present invention compared to a conventional device; and

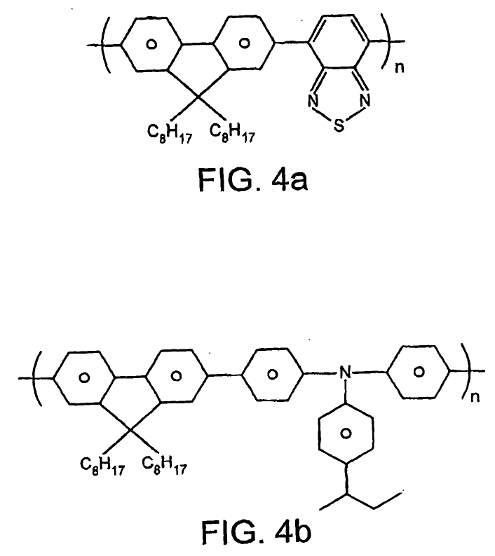

FIG. 4 shows the structure of the component polymers of a polymer blend according to an embodiment of the present invention;

With reference to FIG. 1, a device according to an embodiment of the present invention has a glass substrate 1, a patterned ITO layer (16 mm² pixel) 2 provided on the glass substrate, a layer of a hole transport polymer such as polyethylene dioxythiophene doped with polystyrene sulphonic acid (PEDOT:PSS) 3 providied on the ITO-patterned glass substrate, a layer 4 of a polymer blend consisting of 70 weight percent of an alternating polymer of 9,9′-dioctylfluorene units and benzothiadiazole units (F8BT) as shown in FIG. 4a, and 30 weight percent of an alternating polymer of 9,9′-dioctylfluorene units and triphenylamine units (TFB) as shown in FIG. 4b formed over the hole transport polymer layer, and a cathode 5 formed on the polymer blend layer 4.

The F8BT polymer has an Mₚ of 220,000 and an M_{w} of 123,000; and the TFB polymer has an Mₚ of 102,000 and an M_{w} of 52, 000. The Mₚ and M_{w} were measured by GPC in tetrahydrofuran against a polystyrene standard.

The PEDOT:PSS layer is deposited on the ITO-patterned substrate form a solution composed of PEDOT(10):PSS(1.45):H₂O(8) to a thickness of about 65 nm. The thickness of the polymer blend layer 4 is also about 65 nm. The polymer blend is also deposited by spin coating. The cathode comprises a 30 nm layer of calcium capped with a 300 nm layer of aluminum. The cathode is deposited by evaporation.

In another embodiment, the cathode may include a layer of samarium, ytterbium or cerium instead of calcium (samarium is a preferred alternative for calcium) and/or may further comprise a layer of lithium fluoride interposed between the layer of calcium and the polymer blend layer 4.

The device described above exhibits high peak efficiency and low turn-on voltage (1.9V).

FIG. 2 clearly shows that the same brightness can be achieved at a lower voltage compared to the conventional device. Fox example, the brightness achieved is 10000 Cd/m² at 3.2V (or 1000 Cd/m² at 2.3V) and 35000 Cd/m² at 5V. As shown in FIG. 2, these brightnesses are much larger than those obtained at the same voltages with a corresponding device having an active layer made from a conventional polymer blend comprising a polyfluorene, a fluorene-benzothiadiazole copolymer and a fluorene-triarylamine copolymer.

Furthermore, as is clear from FIG. 3, the drop-off in efficiency with increasing brightness is less pronounced compared to the conventional device.

The luminance and efficiency values are based on a measurement using a silicon photodiode of the amount of emitted light transmitted through the glass substrate. Any emitted light that is waveguided within the device and is transmitted out of the device other than through the glass substrate is not taken into account

This improved performance is particularly significant in the context of pulsed passive matrix displays. All other things being equal, capacitative loss in these displays is proportional to V², where V is the drive voltage. The capability to use a lower drive voltage to achieve the same brightness is highly desirable from the point of view of minimising power dissipation, and may help to simplify the construction of the drive circuit.

1. A polymer blend comprising a first, light-emissive polymer comprising substituted or non-substituted units according to formulae (I) and (II) and a second, hole transport polymer comprising substituted or non-substituted fluorene units according to formula (I) and substituted or non-substituted triarylamine units, wherein the molecular weights of the first and second polymers and the blending ratio of the first and second polymers are selected such that, in use in a light-emissive device, the luminance of the emitted light at a bias of 5V is no less than 20,000 cd/m². 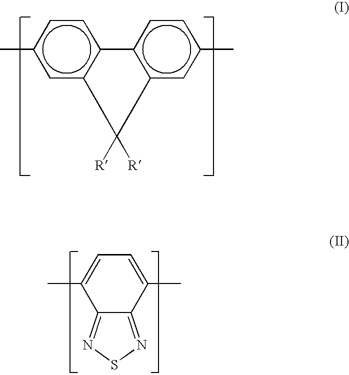
wherein R′ is independently in each occurrence H, C₁-C₂₀ hydrocarbyl or C₁-C₂₀ hydrocarbyl containing one or more S, N, O, P or Si atoms, C₄-C₁₆ hydrocarbyl carbonyloxy, C₄-C₁₆ aryl(trialkylsiloxy) or both R′ may form together with the 9-carbon on the fluorene ring a C₅-C₂₀ cyclic structure optionally containig one or more heteroatoms of S, N or O.

2. A polymer blend according to claim 1 wherein the polymer blend consists essentially of the first and second polymers.

3. A polymer blend according to claim 1 or claim 2 wherein the triarylamine units of the second polymer include one or more types of triarylamine units selected from the group consisting of those according to the following formulae (III)-(VI): 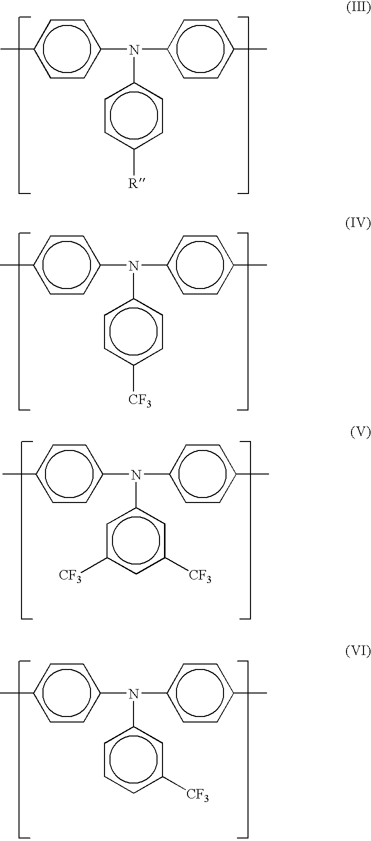
wherein R″ is independently in each occurrence carboxyl, C₁-C₂₀ alkyl, C₁-C₂₀ alkoxy or a group of the formula —CO₂R′″ where in R′″ is a C₁-C₂₀ alkyl.

4. A polymer blend according to claim 3 wherein the second polymer consists of fluorene units and units according to formula (III) of claim 3.

5. A polymer blend according to claim 1 wherein the second polymer comprises alternating fluorene and triarylamine units.

6. A polymer blend according to any preceding claim wherein the proportion of the first polymer in the polymer blend is in the range of 50 to 75 weight percent.

7. A polymer blend according to any preceding claim wherein the proportion of the first polymer in the polymer blend is at least 70 weight percent.

8. A polymer blend according to any preceding claim wherein the molecular weights of the first and second polymers and the blending ratio of the first and second polymers are selected such that, in use in a light-emissive device, the efficiency at a luminance of 30,000 cd/m² is no less than 70% of the peak efficiency.

9. A light-emissive device comprising a layer of a light-emissive material interposed between first and second electrodes such that charge carriers can move between the first and second electrodes and the light-emissive material, wherein the light-emissive material comprises a polymer blend according to any preceding claim.

10. A passive matrix display comprising a light-emissive device according to claim 9.

11. The use of a light-emissive device according to claim 9 in a passive matrix display.

12. A polymer blend consisting essentially of a first, light-emissive polymer comprising substituted or non-substituted units according to formulae (I) and (II) below and a second, hole transport polymer consisting essentially of substituted or non-substituted fluorene units according to formula (I) and substituted or non-substituted triarylamine units, and optionally one or more further hole transport polymers different to the second polymer. 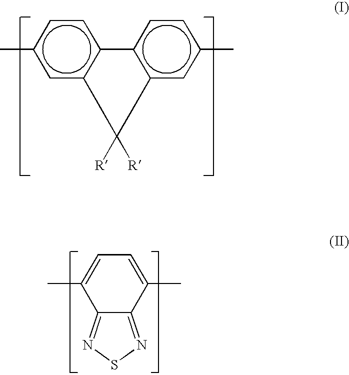
wherein R′ is independently in each occurrence H, C₁-C₂₀ hydrocarbyl or C₁-C₂₀ hydrocarbyl containing one or more S, N, O, P or Si atoms, C₄-C₁₆ hydrocarbyl carbonyloxy, C₄-C₁₆ aryl(trialkylsiloxy) or both R′ may form together with the 9-carbon on the fluorene ring a C₅-C₂₀ cyclic structure optionally containing one or more heteroatoms of S, N or O.

13. A polymer blend according to claim 9 wherein the third polymer comprises triarylamine units different to those contained in the second polymer and fluorene units.

14. A polymer blend according to claim 9 wherein the triarylamine units contained in the third polymer include one or more triarylamine units selected from the group consisting of those according to formulae (III) to (VI) of claim 3.

15. A light-emissive device comprising a light-emissive material interposed between first and second electrodes such that charge carriers can move between the first and second electrodes and the light-emissive material, wherein the light-emissive material comprises a layer of a polymer blend according to any of claims 12 to 14.

16. A light-emissive device according to claim 9 or claim 15 wherein the cathode comprises a layer of calcium, samarium, cerium or ytterbium.
